(19) United States
(12) Patent Application Publication
(10) Pub. No.: US 2024/0428126 A1
(43) Pub. Date: Dec. 26, 2024

(54) PREDICTING SYSTEM STATUS WITH TRUSTWORTHY ARTIFICIAL INTELLIGENCE

(71) Applicant: International Business Machines Corporation, Armonk, NY (US)

(72) Inventors: MING QIAO SHANG GUAN, Beijing (CN); Mai Zeng, Beijing (CN); Meng Wan, Beijing (CN); Xin Xin Dong, Beijing (CN); Sheng Yan Sun, Beijing (CN); Wei Song, Beijing (CN); Wen Zhong Liu, Beijing (CN)

(21) Appl. No.: 18/339,407

(22) Filed: Jun. 22, 2023

(51) Int. Cl. G06N 20/00

(52) U.S. Cl. CPC G06N 20/00

(57) ABSTRACT

One or more systems, devices, computer program products and/or computer-implemented methods of use provided herein relate to training an AI model to predict status of a DBMS. The computer-implemented system can comprise a memory that can store computer executable components. The computer-implemented system can further comprise a processor that can execute the computer executable components stored in the memory, wherein the computer executable components can comprise a data ingestion component that can use testing data of an AI model to generate ingested data by randomly changing one or more records of at least one feature comprised in the testing data, wherein the ingested data can be used to compute a first ratio indicative of inequity of the at least one feature. The computer executable components can further comprise a training component that can train the AI model using at least the first ratio to predict a status of system.

### BACKGROUND

The subject disclosure relates to artificial intelligence (AI) and, more specifically, to predicting system status with trustworthy AI.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that can train a model to predict a status of a system with trustworthy AI are discussed.

According to an embodiment, a computer-implemented system is provided. The computer-implemented system can comprise a memory that can store computer executable components. The computer-implemented system can further comprise a processor that can execute the computer executable components stored in the memory, wherein the computer executable components can comprise a data ingestion component that can use testing data of an AI model to generate ingested data by randomly changing one or more records of at least one feature comprised in the testing data based on a specific rule, wherein the ingested data can be used to compute a first ratio indicative of inequity of the at least one feature. The computer executable components can further comprise a runtime deviation check component that can compare runtime data of the AI model with the ingested data to identify one or more matching records and generate a list comprising at least the one or more matching records. The computer executable components can further comprise a training component that can train the AI model based on an influence factor of the at least one feature, the first ratio of the at least one feature and the list to predict a status of a database management system (DBMS).

According to another embodiment, a computer-implemented method is provided. The computer-implemented method can comprise generating, by a system operatively coupled to a processor, ingested data by randomly changing one or more records of at least one feature comprised in testing data of an AI model based on a specific rule, wherein the ingested data can be used to compute a first ratio indicative of inequity of the at least one feature. The computer-implemented method can further comprise comparing, by the system, runtime data of the AI model with the ingested data to identify one or more matching records and generate a list comprising at least the one or more matching records. The computer-implemented method can further comprise training, by the system, the AI model based on an influence factor of the at least one feature, the first ratio of the at least one feature and the list to predict a status of a DBMS.

According to yet another embodiment, a computer program product for training an AI model to improve robustness of the AI model to training inequity and runtime deviation is provided. The computer program product can comprise a computer readable storage medium having program instructions embodied therewith, the program instructions executable by a processor to cause the processor to generate, by the processor, ingested data by randomly changing one or more records of at least one feature comprised in testing data of an AI model based on a specific rule, wherein the ingested data can be used to compute a first ratio indicative of inequity of the at least one feature. The program instructions can be further executable by the processor to cause the processor to compare, by the processor, runtime data of the AI model with the ingested data to identify one or more matching records and generate a list comprising at least the one or more matching records. The program instructions can be further executable by the processor to cause the processor to train, by the processor, the AI model based on an influence factor of the at least one feature, the first ratio of the at least one feature and the list to predict a status of a DBMS.

### BRIEF DESCRIPTION OF THE DRAWINGS

FIG. 1 illustrates a block diagram of an example, non-limiting system that can train an AI model to predict a status of a DBMS in accordance with one or more embodiments described herein.

FIG. 2 illustrates a block diagram of an example, non-limiting architecture that can train an AI model to predict a status of a DBMS in accordance with one or more embodiments described herein.

FIG. 3 illustrates a flow diagram of an example, non-limiting method that can generate one or more influence factors for training an AI model to predict a status of a DBMS in accordance with one or more embodiments described herein.

FIG. 4 illustrates a flow diagram of an example, non-limiting method that can compute inequity of a feature comprised in testing data of an AI model in accordance with one or more embodiments described herein.

FIG. 5 illustrates a flow diagram of an example, non-limiting method that can generate ingested data for an AI model using one or more features comprised in testing data of the AI model in accordance with one or more embodiments described herein.

FIG. 6 illustrates a flow diagram of an example, non-limiting method that can monitor runtime data of an AI model to provide a runtime deviation check for training the AI model to predict a status of a DBMS in accordance with one or more embodiments described herein.

FIG. 7 illustrates a flow diagram of an example, non-limiting method that can enable monitoring one or more values associated with one or more respective features comprised in testing data of an AI model in accordance with one or more embodiments described herein.

FIG. 8 illustrates a flow diagram of an example, non-limiting method that can enable training an AI model based on factors derived from testing data of the AI model in accordance with one or more embodiments described herein.

FIG. 9 illustrates example, non-limiting decision trees for an AI model trained to predict a status of a DBMS in accordance with one or more embodiments described herein.

FIG. 10 illustrates a flow diagram of an example, non-limiting method that can train an AI model to predict a status of a DBMS in accordance with one or more embodiments described herein.

FIG. 11 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A DBMS can be a valuable part in a customer's business. When monitoring systems, a customer needs to determine whether a DBMS instance is good. One approach to determine a system status for the DBMS can comprise using AI to build a model using a Random Forest algorithm to determine whether the system status for the DBMS is good. Data scientists can use historical data for building AI models to determine the system status. When building an AI model, many features can be taken into consideration, such as, for example, system central-processing unit (CPU) utilization, elapse time, suspension time, processor time, transaction rate, etc. Creating training data for the AI models can comprise determining by DBMS experts whether the system status is good according to multiple features, wherein some features can be more closely related with health of the DBMS than some other features.

Since many factors can be related to the health of the DBMS, it can be beneficial to determine high importance features and inequity features (e.g., bias) that can be helpful for an AI model to improve predictions related to the system status, and to explain significance of the high importance features. Further, given different knowledge backgrounds of different DBMS experts, a DBMS expert may introduce inequity into the training data, resulting in an inequitable (e.g., biased) AI model. Persons/entities responsible for marking the training data can also have different levels of knowledge and experience, and since a workload on a running system (e.g., a running DBMS) can change, it can be beneficial to make a trained AI model explainable and trustworthy.

Various embodiments of the subject innovation can address these issues.

Embodiments described herein include systems, computer-implemented methods, apparatus and computer program products that can enable training an AI model to predict a status of a system (e.g., a DBMS) while maintaining inequity and runtime deviation of the AI model below respective thresholds. For example, the embodiments described herein can enable extracting high influence factors and creating ingested data for finding inequity features of the AI model (e.g., a trained AI model). It is to be appreciated that the inequity features are so called since equity of features in an AI model can be considered for the one or more embodiments herein for training the AI model. The inequity can be a type of bias. The embodiments described herein can further enable checking runtime deviation of the AI model, adjusting weights of inequity features, and retraining the AI model based on an inequity ratio of at least one feature and a real hit ratio for the AI model, which can improve robustness of the AI model to training inequity and runtime deviation.

At runtime, a system programmer can determine whether the system status for the DBMS is healthy. Thus, runtime data can be used to validate the AI model and generate feedback for model training. As stated earlier, several factors can impact performance of a DBMS at the system level. Some exemplary DBMS factors can comprise NUMLKUS which can be maximum locks per user, NUMLKTS which can be maximum locks per user per table space, BUFFER_UPDATES which can be number of times a buffer update occurred for system pages, PAGES_WRITTEN which can be number of pages written for a buffer pool, SEQ_PREFETCH_PAGE which can be number of pages read because of sequential prefetch requests issued for the buffer pool, ACT_ALLIED_THREADS, CUR OPEN DATASETS which can be number of datasets currently open, MAX UTILS PARALLELISM, MAX STORAGES FOR LOCK, MAXDEGREE, LOG RATE, REAL_STORAGE_FRAME, etc. Changes in size of a workload and rating changes can also generate various performance influences in the DBMS, such as, for example, parallelism, lock, real storage, buffer pool, utility, and logging. Thus, finding high influence factors that can be used for dynamically adjusting various parameters more precisely can assist the DBMS to exhibit a better performance. It is to be appreciated that a focus of the subject innovation is training an AI model to predict status of a system such as a DBMS versus individual database performance numbers.

A method for training the AI model to predict the status of the system (e.g., to predict whether health of the system is good) can comprise using testing data of the AI model to generate high influence factors for one or more features of the testing data. An influence factor can be a numeric value for a feature comprised in the testing data and be indicative of how much the feature influences prediction results of the AI model. For example, a high influence factor (e.g., an influence factor value above some specified threshold) can indicate that changing a value of a feature corresponding to the influence factor can likely change prediction results of the AI model. A training component can first train the AI model using historical data to generate a trained AI model. For example, from the historical data, SMF data (e.g., system data) can be collected by a data collection module, and the SMF data can be split into training data and testing data. The training component can use the training data to train the AI model to predict status of the system.

Thereafter, a factor identification module can extract influence factors for features comprised in the testing data using the AI model. For example, the testing data can be processed by the AI model to generate an output that can be the original score. Thereafter, the factor identification module can randomly change a value for a feature of the testing data to generate new test data, and the new test data comprising the changed value for the feature can be processed by the AI model to generate a new score for the AI model. The factor identification module can compute a difference between the original score and the new score, wherein the difference can be equal to an influence factor for the feature. The process can be repeated for additional features comprised in the testing data.

Thereafter, the method can comprise creating ingested data by changing a value of one or more features from the testing data based on a rule, wherein the rule can comprise randomly change the value of a feature to another value in the set or scope of the value. For example, a data ingestion module can select high influence factors (e.g., influence factors having values greater than a specified threshold) from an influence factor table (e.g., table 1) generated for the AI model (e.g., top N influence factors, wherein N can be defined by a user of the AI model). The data ingestion module can change values for features corresponding to the high influence factors to generated ingested data. For example, a feature corresponding to a high influence factor can comprise one or more records, and the data ingestion module can randomly change respective values of the one or more records in the testing data to generate one or more ingested records. The process can be repeated for additional features corresponding to the high influence factors. For example, a value of a feature can be divided into different categories and a value of a record of the feature can be changed to another category to create a new record, wherein data ingestion component 110 can randomly the choose one or more respective values in another category to create the one or more ingested records.

Further, the data ingestion module can determine inequity ratios for the features corresponding to the high influence factors. For example, for each feature, the AI model can generate prediction results based on the one or more records (e.g., original records) and the one or more ingested records (e.g., ingested records). The data ingestion module can compare the prediction results of the AI model for the original records and the ingested records of a feature to generate an inequity ratio of the feature, wherein the inequity ratio can be indicative of inequity of the feature. For example, if prediction results of the AI model for the ingested records of the feature are different than prediction results for the original records of the feature, the data ingestion module can add 1 to an inequity count number for the feature. An inequity ratio for the feature can be computed by dividing the new inequity count number for the feature by total number of records for the feature. Respective inequity ratios can be thus determined for the features corresponding to the high influence factors.

The method can further comprise a runtime deviation check module that can check runtime data of the AI model and compare the runtime data with the ingested data to identify matching records in the runtime data and the ingested data. The matching records can be added to a hit list along with prediction results of the AI model for the matching records, and a system programmer can be involved to provide feedback based on the prediction results of the AI model. Thereafter, a trust monitor module can monitor the inequity ratios, the high influence factors, and the hit list to generate feedback for a trust model manager, wherein the feedback can comprise inequity ratios above a threshold, influence factors over a first threshold and a real hit ratio. The trust monitor module can compute the real hit ratio for the AI model using data from the list. For example, the trust monitor module can compute the real hit ratio based on an amount of matching records (e.g., which records of the runtime data exist in the ingested data) for which model prediction results can be the same as operator results marked by a system operator (e.g., feedback from a human entity on the model prediction results) and number of records in the hit list. The real hit ratio can be computed according to equation 1.

Real hit ratio=(number of matching records for which model prediction results are the same as system operator results)/(number of records in the hit list) Equation 1:

Based on information from the trust monitor module, the trust model manager can further adjust feature weights and provide feedback to retrain the AI model to improve fairness and deviation of the AI model. For example, the trust model manager can use influence factors as initial weights for respective inequity features and adjust the initial weights for the inequity features having an inequity ratio over a threshold, wherein adjusting an initial weight for a feature can comprise, for example, lowering a weight of the inequity feature such than influence of the inequity feature on performance of the AI model can be reduced. A data collection module can collect and format data used for implementing the one or more embodiments herein, wherein continuous data can be formatted to different classes according to a profile. A model training module can first train the AI model using historical data and the model training module can accept a request of the trust model manager to retrain the AI model using parameters/adjusted weights for the respective inequity features provided by the trust model manager. The trust model manager can be used to understand or explain the AI model with respect to the historical and running data. For example, the trust model manger can acquire names of inequity features and corresponding influence factors to identify whether a high influence factor has high inequity.

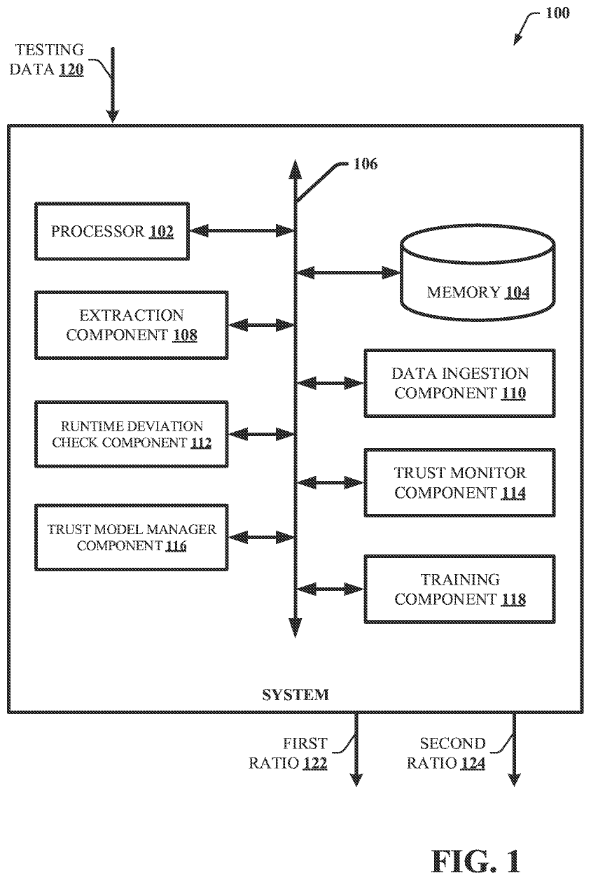

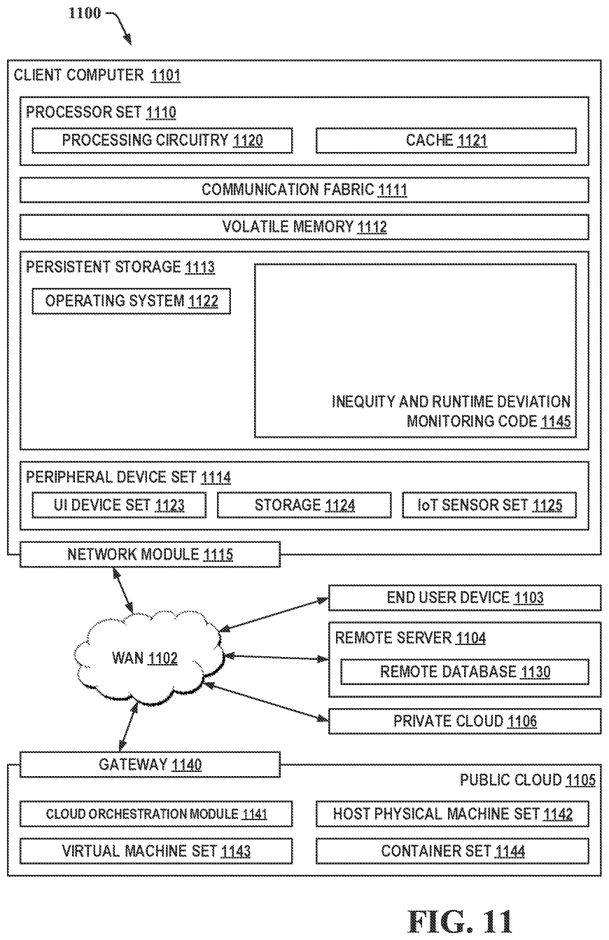

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computers and/or computing-based elements described herein with reference to an operating environment, such as the operating environment 1100 illustrated at FIG. 11. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can train an AI model to predict a status of a DBMS in accordance with one or more embodiments described herein. System 100 can comprise processor 102, memory 104, system bus 106, extraction component 108, data ingestion component 110, runtime deviation check component 112, trust monitor component 114, trust model manager component 116, and training component 118.

The system 100 and/or the components of the system 100 can be employed to use hardware and/or software to solve problems that are highly technical in nature (e.g., related to machine learning, artificial intelligence, training an AI model to predict a status of a DBMS, etc.), that are not abstract and that cannot be performed as a set of mental acts by a human. Further, some of the processes performed may be performed by specialized computers for carrying out defined tasks related to the training of the AI model to predict a status of a DBMS. The system 100 and/or components of the system can be employed to solve problems that can arise through involvement of subject matter experts (SME) with different levels of expertise in a pipeline for training the AI model, changes in workload of a running system and the like. The system 100 can provide technical improvements/solutions to AI systems by improving robustness of the AI model to training inequity and runtime deviation, building explainable and trustworthy AI models, etc.

Discussion turns briefly to processor 102, memory 104 and bus 106 of system 100. For example, in one or more embodiments, the system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., extraction component 108, data ingestion component 110, runtime deviation check component 112, trust monitor component 114, trust model manager component 116, and/or training component 118) to perform one or more actions. In one or more embodiments, memory 104 can store computer-executable components (e.g., extraction component 108, data ingestion component 110, runtime deviation check component 112, trust monitor component 114, trust model manager component 116, and/or training component 118).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). For example, data ingestion component 110 can use the testing data of the AI model to generate ingested data by randomly changing one or more records of the at least one feature comprised in the testing data. Runtime deviation check component 112 can compare runtime data of the AI model with the ingested data to identify one or more matching records and generate a list comprising at least the one or more matching records. Training component 118 can train the AI model based on the influence factor of the at least one feature, the first ratio of the at least one feature and the list to predict a status of a database management system, additional details of which are disclosed hereinafter. System 100 can be associated with, such as accessible via, a computing environment 1100 described below with reference to FIG. 11. For example, system 100 can be associated with a computing environment 1100 such that aspects of processing can be distributed between system 100 and the computing environment 1100.

In one or more embodiments, an extraction component (e.g., extraction component 108) can extract one or more influence factors for one or more respective features of testing data (e.g., testing data 120) of an AI model, wherein at least one feature can be selected for generating ingested data for the AI model based on an influence factor of the at least one feature being greater than a first threshold. For example, the testing data can be processed by the AI model to generate an output that can be the original score. The extraction component can randomly change a value for the at least one feature of the testing data to generate new test data, and the new test data comprising the changed value for the at least one feature can be processed by the AI model to generate a new score for the AI model. The extraction component can compute a difference between the original score and the new score, wherein the difference can be an influence factor for the at least one feature. The process can be repeated for additional features comprised in the testing data.

A data ingestion component (e.g., data ingestion component 110) can use the testing data of the AI model to generate the ingested data. Generating the ingested data can comprise generating one or more ingested records for the at least one feature based on one or more existing records for the at least one feature in the testing data. For example, the data ingestion component can select high influence factors (e.g., influence factors having values greater than a specified threshold) generated for the AI model, wherein the at least one feature can correspond to a high influence factor. The data ingestion component can randomly change respective values of records of the at least one feature comprised in the testing data based on a specific rule to generate ingested records for the at least one feature, wherein the ingested records can be used to compute a first ratio (e.g., first ratio 122 or inequity ratio) indicative of inequity of the at least one feature, as discussed below.

The first ratio can be generated based on an amount of records comprised in the ingested data and an inequity count of the at least one feature determined using the AI model. The inequity count of the at least one feature can be determined by comparing prediction results generated by the AI model based on processing original records of the at least one feature in the testing data of the AI model and the ingested records of the at least one feature. For example, for the at least one feature, the AI model can generate prediction results based on the original records and the ingested records. The data ingestion component can compare the prediction results of the AI model for the original records and the ingested records of a feature to generate an inequity ratio of the at least one feature, wherein the inequity ratio can be indicative of inequity of the at least one feature. If the prediction results for the ingested records are different than prediction results for the original records, the data ingestion component can add 1 to an inequity count number for the at least one feature. The data ingestion component can compute the inequity ratio for the at least one feature by dividing the inequity count number (e.g., new inequity count number) for the at least one feature by total number of records of the at least one feature. Respective inequity ratios can be thus determined for respective features of the testing data corresponding to the high influence factors.

A runtime deviation check component (e.g., runtime deviation check component 112) can compare runtime data of the AI model with the ingested data to identify one or more matching records and generate a list comprising at least the one or more matching records. The list can further comprise prediction results generated by the AI model based on processing the one or more matching records. For example, the runtime deviation check component can use the AI model to mark the one or more matching records as red, yellow or green, wherein the red, yellow or green designations can be indicative of health of the system (e.g., DBMS). Further, the runtime deviation check component can notify a system programmer to check for an existing status (e.g., good or bad) of the system (e.g., DBMS). The system programmer can check the system environment and give feedback to the runtime deviation check component over the prediction results generated by the AI model based on processing the one or more matching records. For example, the system programmer can additionally mark the matching record as red, yellow or green. The runtime deviation check component can add a matching record the list, wherein the list can comprise the prediction results and the feedback from the system programmer. A difference between the prediction results made by the AI model and the feedback generated by the system programmer can indicate that a performance of the AI model at runtime is below a performance threshold.

A trust monitor component (e.g., trust monitor component 114) can monitor the influence factor for the at least one feature, the first ratio of the at least one feature and the list, and generate a second ratio (e.g., second ratio 124 or real hit ratio) based on the list. For example, the trust monitor component can compute the second ratio for the AI model using data from the list. For example, the second ratio can be computed by dividing an amount of matching records (e.g., which records of the runtime data exist in the ingested data) for which the prediction results made by the AI model can be the same as the feedback generated by the system operator (e.g., a human entity) by an amount of records in the list (e.g., according to equation 1). A trust model manager component (e.g., trust model manager component 116) can generate feedback for training the AI model based on at least the first ratio being greater than a threshold or the second ratio being lower than a second threshold, and the trust model manager component can adjust a weight of the at least one feature based on a determination that the at least one feature is inequitable (i.e., based on a determination that the at least one feature is an inequity feature). For example, the trust model manager can use an influence factor as an initial weight for the at least one feature and adjust the initial weight for the at least one feature when the inequity ratio of the at least one feature is over a threshold (e.g., lower a weight of a specific inequity feature).

A training component (e.g., training component 118) can train the AI model based on the influence factor of the at least one feature, the first ratio of the at least one feature and the list to predict a status of a database management system while maintaining inequity and runtime deviation of the AI model below respective thresholds. In other words, the training component can train the AI model based on the adjusted weight for the at least one feature generated by the trust model manager component based on analysis of at least the influence factor of the at least one feature, the first ratio of the at least one feature and the list. Additionally, a data collection module can collect and format data used for implementing the one or more embodiments herein. Data sources in a system management facility (SMF) can comprise system layer data such as CPU utilization, TranRate, clapse time, etc., wherein SMF is a concept in IBM's z/OS system. The data sources can also comprise DBMS layer data such as CL1 Elapse Time, CL2 CPU time, CL3 Suspension Time, DB log rate, etc. from a DBMS layer. The features listed herein (e.g., CPU utilization, DB log rate, etc.) are examples of features of data that can be collected. For example, CPU utilization can be CPU utilization of a system that can be collected by the SMF, TranRate is a transaction rate for a data base, CL1 elapse time is the class 1 elapsed time of an allied agent, log rate is a number of log serial write requests, etc. Continuous data can be formatted to different classes according to a profile.

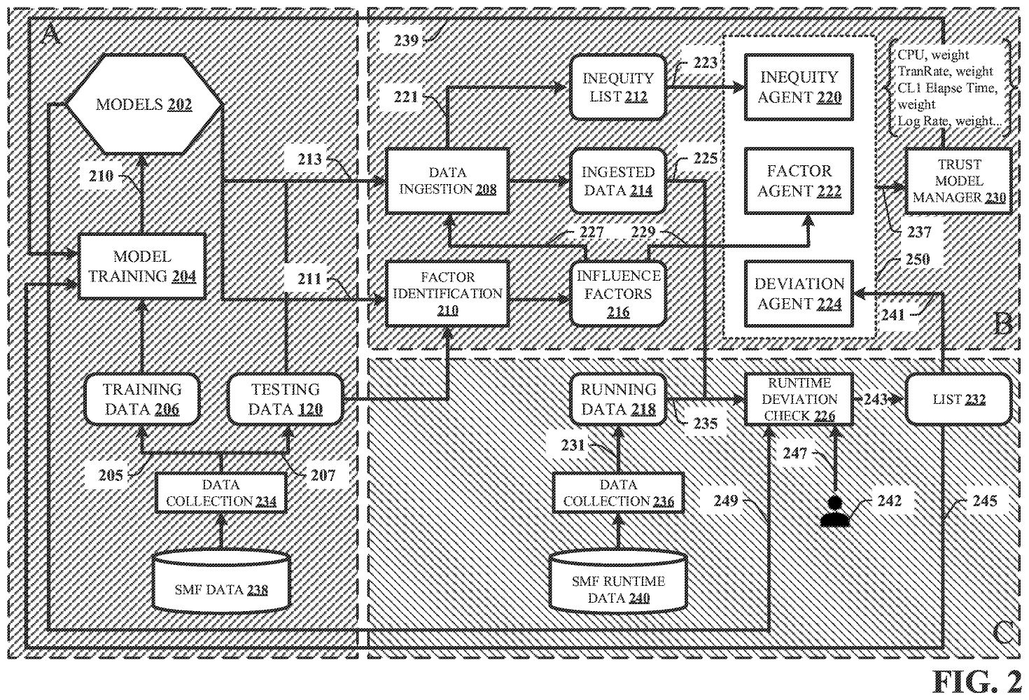

FIG. 2 illustrates a block diagram of an example, non-limiting architecture that can train an AI model to predict a status of a DBMS in accordance with one or more embodiments described herein. Repetitive description of like elements and/or processes employed in respective embodiments is omitted for sake of brevity.

In one or more embodiments, an AI model can be trained to predict a status of a DBMS via the architecture illustrated in FIG. 2, wherein block A can illustrate a data collection and training portion of the architecture, block B can illustrate an AI management portion of the architecture, and block C can illustrate a system runtime portion of the architecture. At model training 204, training component 118 (FIG. 1) can first train the AI model using historical data to generate a trained AI model. For example, from the historical data, SMF data 238 (e.g., system data) can be collected by a data collection module at data collection 234, and SMF data 238 can be split into training data 206 (e.g., at 205) and testing data 120 (e.g., at 207). Training component 118 can use training data 206 to train the AI model. At 210, training component 118 can generate models 202 (e.g., model M1, model M2, . . . , model Mn) to predict a status of the DBMS using a Random Forest algorithm, wherein a decision tree can correspond to one AI model. A Random Forest algorithm comprises several individual decision trees, wherein each individual decision tree in the random forest can spit out a class prediction. The prediction value of the Random Forest algorithm is an average of prediction values of all decision trees in the algorithm. Various embodiments herein can employ the Random Forest algorithm without any changes to the algorithm. Thus, multiple decision trees representing potential AI models can be generated. One or more models 202 can be used to generate a final result regarding a health status of the DBMS.

At factor identification 210, a factor identification module or extraction component 108 can generate one or more influence factors 216 corresponding to one or more respective features of testing data 120. For example, at 211, extraction component 108 can use an AI model (e.g., trained AI model, models 202) to find an influence factor for each feature in a test dataset of testing data 120. An influence factor can be a numeric value for a feature comprised in testing data 120 and be indicative of how much the feature influences prediction results of the AI model. For example, a high influence factor (e.g., an influence factor value above some specified threshold) can indicate that changing a value of a feature corresponding to the influence factor can likely change prediction results of the AI model. To determine an influence factor (e.g., of influence factors 216), extraction component 108 can generate an original score for the AI model (e.g., trained AI model) using testing data 120. For example, testing data 120 can be processed by the AI model to generate an output that can be the original score. Thereafter, extraction component 108 can randomly change a value (e.g., in a column) for a first feature of testing data 120 to generate a new testing dataset, and extraction component 108 can use the new testing dataset to generate a new score for the AI model. For example, the new testing dataset can be processed by the AI model to generate an output that can be the new score. A difference between the original score and the new score can be equal to the influence factor for the feature (i.e., |original score−new score|=influence factor). As such, one or more influence factors 216 can be generated for one or more respective features of testing data 120, and influence factors 216 can be tabulated in an influence factor table. A high influence factor (e.g., an influence factor value above some specified threshold) can indicate that changing a value of a feature corresponding to the influence factor can likely change prediction results of the AI model. Features with higher influence factors than others can imply that such features need to be taken into consideration first when training a model. Table 1 lists exemplary values of influence factors of exemplary features of a test dataset.

TABLE 1
Influence factor table

| Feature | Influence factor |
|---|---|
| A | 0.53 |
| B | 0.2 |
| C | 0.4 |
| D | 0.3 |
| E | 0.15 |

At data ingestion 208, a data ingestion module or data ingestion component 110 can generate ingested data 214 using testing data 120 to calculate inequity of one or more features in testing data 120. For example, at 213, data ingestion component 110 can use an AI model (e.g., trained AI model, models 202) to select one or more features from testing data 120 wherein the one or more features have influence factors above a defined threshold or first threshold (e.g., features with top N influence factors, wherein N can be a number defined by a user of the AI model). For example, as described above, extraction component 108 can generate one or more influence factors 216 for one or more respective features of testing data 120 and features corresponding to influence factors having values greater than a defined threshold can be selected (e.g., at 227 by data ingestion component 110) to generate ingested data 214. Data ingestion component 110 can generate ingested data 214 by randomly changing values of one or more existing records for each feature thus selected based on a specific rule (wherein the specific rule can be to randomly change the values, however a user can also define rules). For example, by randomly changing values of one or more existing records for a feature selected for generating ingested data 214 (e.g., a feature having an influence factor greater than a defined threshold), data ingestion component 110 can generate one or more ingested records for the feature.

Data ingestion component 110 can use ingested data 214 to compute inequity list 212. For example, for each feature of ingested data 214, data ingestion component 110 can use an AI model (e.g., trained AI model) to generate first data and second data. First data can comprise results generated by the AI model based on original values of features selected to generate ingested data 214, and second data can comprise results generated by the AI model based on values of the features in ingested data 214 (i.e., randomly changed values of one or more records of the features). Data ingestion component 110 can compute inequity list 212 by comparing respective values for each feature from the first data and the second data. For example, if a value in the second data is different than a corresponding value in the first data, an inequity count/inequity count number (represented as B_Count(F)) for the feature can increase by addition of 1 to the inequity count number (e.g., new B_Count(F)=B_Count(F)+1). If the value in the second data is the same, the inequity count number (i.e., B_Count(F)) does not change and the process can move to the next feature. Further, data ingestion component 110 can generate an inequity ratio (e.g., first ratio 122) for each feature of ingested data 214. For example, for a total of n records in ingested data 214, an inequity ratio for a feature associated with ingested data 214 can be equal to the inequity count for the feature (e.g., B_Count(F)) divided by n (e.g., B_Count(F)/n). Table 2 lists exemplary values of inequity ratios for exemplary features (e.g., features A-E listed in table 1) of a test dataset. For example, feature C can have a high inequity ratio of 90% which can indicate that feature C is a sensitive feature and changing a value of feature C can cause a prediction result for the AI model to also change. As such, features that can introduce inequity can be identified.

TABLE 2
Inequity list

| Feature | Inequity ratio |
|---|---|
| A | 50% |
| B | 60% |
| C | 90% |
| D | 10% |
| E | 30% |

At runtime deviation check 226, a runtime deviation check module or runtime deviation check component 112 can monitor running data 218 and ingested data 214 to further assist in generating the AI model for predicting the status of the DBMS. For example, at data collection 236, the data collection module can collect SMF runtime data 240 (e.g., data from system runtime) to generate running data 218, at 231. For example, SMF runtime data 240 can contain all system monitoring data and runtime data 218 can be a record created by the data collection module, wherein runtime data 218 can be specific to/required for the AI model. At 249, runtime deviation check component 112 can use the AI model (e.g., trained AI model, models 202) to monitor running data 218 (e.g., at 235) and ingested data 214 (e.g., at 225) to identify matching records, wherein a record from running data 218 matching a record from ingested data 214 can indicate prior occurrence of a situation corresponding to the record (i.e., the situation has occurred before in time). Upon identification of a matching record, runtime deviation check component 112 can use the AI model (e.g., trained AI model) to generate prediction results based on the matching record. For example, runtime deviation check component 112 can use the AI model to mark/make predictions for the matching records.

Further, runtime deviation check component 112 can notify system programmer 242 to check for existing status (e.g., good or bad) of the system (e.g., DBMS). System programmer 242 can check the system environment and give feedback to runtime deviation check component 112 over predictions made by the AI model for the matching record, wherein the feedback can comprise a second set of results based on the matching record. At 243, runtime deviation check component 112 can add the matching record to a hit list or list 232, wherein list 232 can comprise the prediction results and the second set of results from system programmer 242 (or system operator). List 232 can be used to identify whether the prediction results match the second set of results and to generate a real hit ratio (e.g., second ratio 124) for the AI model (e.g., the trained AI model).

At 250, a trust monitor or trust monitor component 114 can monitor inequity list 212, influence factors 216 and list 232 respectively using inequity agent 220, factor agent 222 and deviation agent 224. For example, at 223, inequity agent 220 can monitor inequity list 212 for inequity ratios with values over a threshold, and at 237, inequity agent 220 can notify trust model manager 230 of such inequity ratios. At 229, factor agent 222 can monitor the influence factors 216 (e.g., listed in an influence factor table) to acquire top N influence factors for trust model manager 230. At 241, deviation agent 224 can monitor list 232 and calculate the real hit ratio (e.g., second ratio 124) at intervals. For example, deviation agent 224 can compute the real hit ratio based on an amount of matching records for which the prediction results and the second set of results are the same and an amount of records in list 232 according to equation 1. At 237, deviation agent 224 can notify trust model manager 230 when a real hit ratio exceeds a defined threshold (i.e., second threshold).

At 239, trust model manager 230 can generate feedback for retraining the AI model (e.g., the trained AI model) according to the real hit ratio and the inequity ratio. For example, at 245, list 232 can be used at model training 204 to retrain the AI model. Trust model manager 230 can collect information from trust monitor component 114 and check the inequity ratio and the real hit ratio to decide whether to retrain the AI model using new parameters. For example, trust model manager 230 can get inequity list 212, an influence factor table (e.g., table 1), and list 232, and trust model manager 230 can check for inequity ratios with values over the threshold, features with top N influence factors (e.g., IF (f)), and the real hit ratio. An average value of the influence factors can be represented as avg (IF), wherein avg (IF) can be computed (e.g., by trust monitor component 114) according to equation 3. Trust model manager 230 can check whether the real hit ratio is lower than the defined threshold (i.e., second threshold) or if an inequity ratio is over the threshold. A real hit ratio lower than the defined threshold can indicate presence of a situation that the AI model does not cover, which can further indicate that the AI model is not suitable for runtime. Trust model manager 230 can trigger a retrain of the AI model (e.g., trained AI model) at intervals (e.g., defined time intervals), when the real hit ratio is lower that the defined threshold (i.e., second threshold), or when the inequity ratio is over the threshold, using the features with the top N influence factors (e.g., one or more features from testing data 120 having influence factors above a defined threshold (i.e., first threshold)) and adjust respective weights of inequity features (e.g., CPU weight, TranRate weight, CL1 elapse time weight, log rate weight, etc.). Additional aspects of one or more embodiments disclosed herein are described in greater detail with reference to subsequent figures.

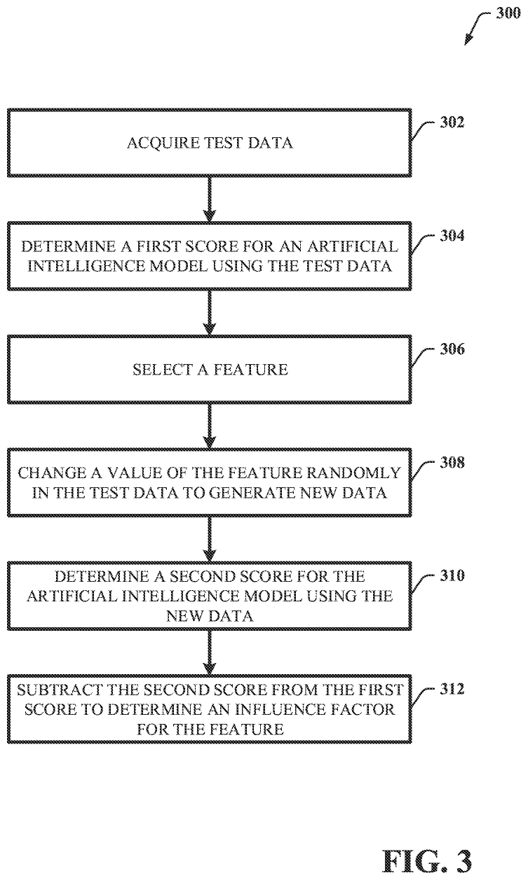

FIG. 3 illustrates a flow diagram of an example, non-limiting method 300 that can generate one or more influence factors for training an AI model to predict a status of a DBMS in accordance with one or more embodiments described herein. Repetitive description of like elements and/or processes employed in respective embodiments is omitted for sake of brevity.

As discussed with reference to FIG. 2, extraction component 108 can use an AI model (e.g., trained AI model) to find an influence factor for each feature comprised in test data (e.g., testing data 120) of the AI model. For example, at 302, extraction component 108 can acquire test data of the AI model. At 304, extraction component 108 can determine a score (i.e., a first score) for the AI model using the test data (e.g., based on the AI model processing the test data to generate the score). At 306, extraction component 108 can select a feature from the test data. At 308, extraction component 108 can randomly change a value of the feature in the test data to generate new data. At 310, extraction component 108 can determine a new score (i.e., a second score) for the AI model by using the new data (e.g., based on the AI model processing the new data to generate the new score). At 312, extraction component 108 can subtract the second score from the first score to generate an influence factor for the feature (e.g., Inf factor=|score-new score|). It is to be appreciated that extraction component 108 can be a factor identification module.

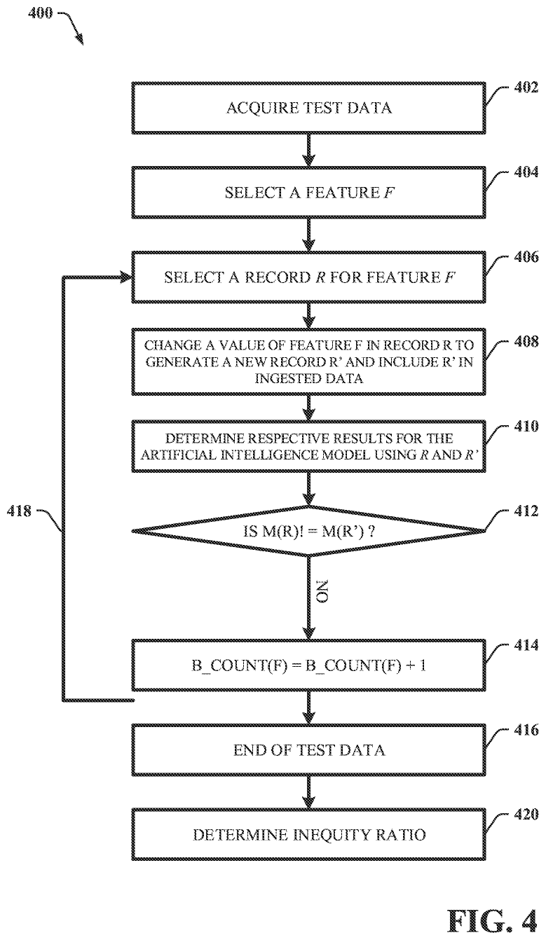

FIG. 4 illustrates a flow diagram of an example, non-limiting method 400 that can compute inequity of a feature comprised in testing data of an AI model in accordance with one or more embodiments described herein. Repetitive description of like elements and/or processes employed in respective embodiments is omitted for sake of brevity.

As discussed with reference to FIG. 2, data ingestion component 110 can use an AI model (e.g., trained AI model) to generate ingested data (e.g., ingested data 214) to further generate respective inequity ratios for one or more features of test data (e.g., testing data 120) of the AI model. For example, at 402, data ingestion component 110 can acquire test data of the AI model. More specifically, data ingestion component 110 can acquire one or more features from test data of the AI model having influence factors above a first threshold. At 404, data ingestion component 110 can select a feature F from the test data. At 406, data ingestion component 110 can select a record R for the feature F. At 408, data ingestion component 110 can change a value of feature F in record R to generate a new record R′ and include the new record R′ in ingested data. At 410, data ingestion component 110 can determine respective results for the AI model using the record R and the new record R′. For example, an output of the AI model (e.g., model M) based on record R can be M(R)! and an output of AI model M based on new record R′ can be M(R′).

At 412, data ingestion component 110 can determine if M(R)! is equal to M(R′) (e.g., if M(R)!=M(R′)). At 414, data ingestion component 110 can add 1 to an inequity count for feature F if M(R)! is not equal to M(R′). For example, data ingestion component 110 can generate an inequity count/inequity count number (e.g., B_Count(F)) for feature F by adding 1 to the inequity count number (e.g., B_Count(F)=B_Count(F)+1). At 416, method 400 can conclude for feature F and at 418, data ingestion component 110 can select a new feature to generate an inequity count for the new feature using steps 402-414 of method 400. At 420, data ingestion component 110 can determine an inequity ratio for feature F and other additional features. For example, for a total of n records in the ingested data, an inequity ratio for feature F can be equal to the inequity count for feature F (e.g., B_Count(F)) divided by n (e.g., inequity ratio for feature F=B_Count(F)/n).

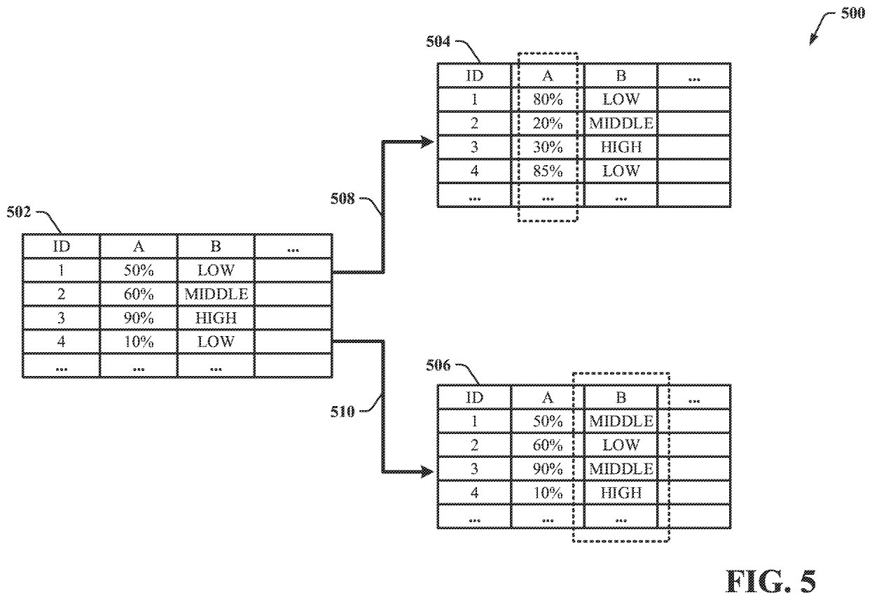

FIG. 5 illustrates a flow diagram of an example, non-limiting method 500 that can generate ingested data for an AI model using one or more features comprised in testing data of the AI model in accordance with one or more embodiments described herein. Repetitive description of like elements and/or processes employed in respective embodiments is omitted for sake of brevity.

As discussed with reference to at least FIG. 4, data ingestion component 110 can use an AI model (e.g., trained AI model) to enable generation of ingested data (e.g., ingested data 214 of FIG. 2) for training the AI model to predict a status of a DBMS. For example, data ingestion component 110 can select one or more features from testing data of the AI model having respective one or more influence factors above a defined threshold (i.e., first threshold), and data ingestion component 110 can randomly change one or more respective values of one or more records for each feature thus selected to generate one or more ingested records for each feature. For example, a value of a feature can be divided into different categories and a value of a record of the feature can be changed to another category to create a new record, wherein data ingestion component 110 can randomly choose the one or more respective values in the other category to create the one or more ingested records. The one or more ingested records can form the ingested data for the AI model.

For example, table 502 can illustrate values of records for features A and B, wherein features A and B can be comprised in testing data for an AI model and have influence factors above a first threshold. It is to be appreciated that table 502 can comprise additional factors (e.g., C, D, etc.) and the values listed in table 502 are exemplary. At 508, by randomly changing values of records for feature A, data ingestion component 110 can generate ingested records for feature A, as highlighted by the dashed shape in the second column of table 504. For example, a value of 50 percent (50%) in table 502 for feature A can be randomly changed to 80% to generate an ingested record for feature A. Similarly, at 510, by randomly changing values of records for feature B, data ingestion component 110 can generate ingested records for feature B, as highlighted by the dashed shape in the third column of table 506. For example, a value of “low” in table 502 for feature B can be randomly changed to “middle” to generate an ingested record for feature B.

In a non-limiting example, feature A or feature B can be a CPU utilization value, and to create ingested data for the feature, data ingestion component 110 can check a column of the feature and change each value in the column to another value in a value range. For example, an existing/current value for a record for CPU utilization can be 30%, and the CPU utilization value can be marked into a value range of the value ranges [0, 50%], [50%, 80%], [80%, 100%]. To generated ingested data for the feature, a value in another range (e.g., 70%) can be chosen as a new value to construct a new record. Further, a runtime deviation check component (e.g., runtime deviation check component 112) can compare runtime data of the AI model with the ingested data to identify one or more matching records, additional aspects of which are disclosed with reference to subsequent figures.

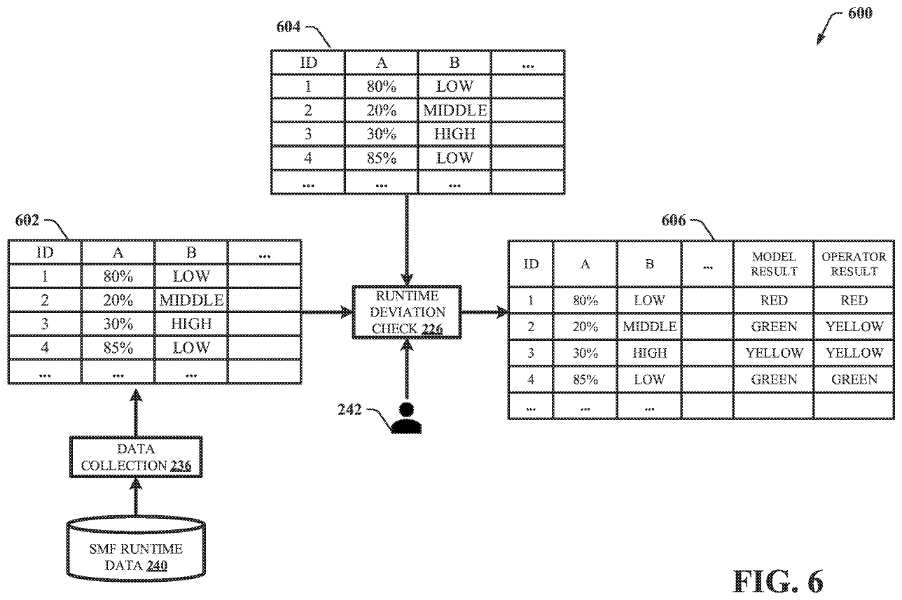

FIG. 6 illustrates a flow diagram of an example, non-limiting method 600 that can monitor runtime data of an AI model to provide a runtime deviation check for training the AI model to predict a status of a DBMS in accordance with one or more embodiments described herein. Repetitive description of like elements and/or processes employed in respective embodiments is omitted for sake of brevity.

As discussed with reference to at least FIGS. 2 and 5, runtime deviation check component 112 can monitor running data (e.g., running data 218) and ingested data (e.g., ingested data 214) for an AI model (e.g., trained AI model). For example, at data collection 236, a data collection module can collect SMF runtime data 240 (e.g., data from system runtime) to generate running data. Runtime deviation check component 112 can use the AI model to monitor the running data and the ingested data to identify matching records, wherein a record from the running data matching a record from the ingested data can indicate prior occurrence of a situation corresponding to the record (i.e., the situation has occurred before in time). For example, table 602 can represent the running data and table 604 can represent the ingested data, wherein values listed in table 602 can be identical to ingested data values from table 604. For example, a value for feature A can be 60% and a value for feature B can be “low” in table 602 and table 604. Table 602 and table 604 can represent a matching record, and upon identification of such a matching record, runtime deviation check component 112 can use the AI model to generate prediction results based on the matching record. For example, runtime deviation check component 112 can use the AI model to mark the matching record as red, yellow or green as listed in the “model result” column in table 606, wherein the red, yellow or green designation can be indicative of health of the system (e.g., DBMS).

Further, runtime deviation check component 112 can notify system programmer 242 to check for existing status (e.g., good or bad) of the system (e.g., DBMS). System programmer 242 can check the system environment and give feedback to runtime deviation check component 112 in connection with the matching record, wherein the feedback can comprise a second set of results based on the matching record. For example, system programmer can additionally mark the matching record as red, yellow or green, as listed in the “operator result” column in table 606, wherein the second set of results (operator results) can be similar to or different than the prediction results (model results). For example, for the records of features A and B in the second row (e.g., 80%, low) of table 606, the model results and the operator result can both be designated “red,” whereas for the records of features A and B in the third row (e.g., 20%, middle) of table 606, the model result can be “green,” and the operator result can be “yellow.”

Model results (e.g., prediction results) generated by the AI model using the runtime data can often be imprecise and be indicative of runtime deviation. The operator results (e.g., second set of results) can indicate feedback provided by system programmer 242 on the health of the system. A difference between the model results and the operator results can indicate that a performance of the AI model at runtime is below a performance threshold. Thus, identification of differences between the model results and the operator results can be used to trigger feedback to retrain the AI model. Runtime deviation check component 112 can add the matching record to a hit list (e.g., list 232), wherein the hit list can comprise the prediction results generated by the AI model and the second set of results from system programmer 242 (or system operator). The hit list can be used to generate a real hit ratio for the AI model to determine whether the prediction results and the second set of results match.

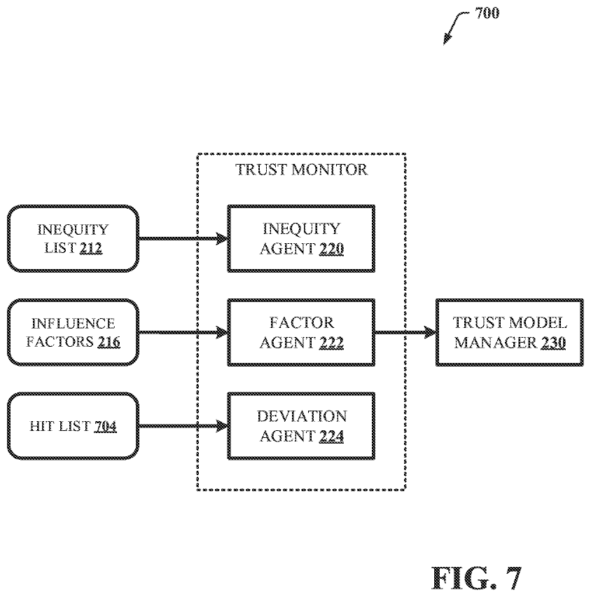

FIG. 7 illustrates a flow diagram of an example, non-limiting method 700 that can enable monitoring one or more values associated with one or more respective features comprised in testing data of an AI model in accordance with one or more embodiments described herein. Repetitive description of like elements and/or processes employed in respective embodiments is omitted for sake of brevity.

As discussed with reference to FIG. 2, a trust monitor or trust monitor component 114 can monitor inequity list 212, influence factors 216 and hit list 702 (e.g., list 232). Trust monitor component 114 can comprise inequity agent 220, factor agent 222 and deviation agent 224 that can respectively monitor inequity list 212, influence factors 216 and hit list 702 (e.g., list 232). For example, inequity agent 220 can monitor inequity list 212 for inequity ratios with values over a threshold, and inequity agent 220 can notify trust model manager 230 of such inequity ratios. Factor agent 222 can monitor the influence factors 216 (e.g., listed in an influence factor table) to acquire top N factors for trust model manager 230. Deviation agent 224 can monitor hit list 704 and calculate a real hit ratio at intervals, and deviation agent 224 can notify trust model manager 230 when a real hit ratio exceeds a defined threshold or second threshold. Thereafter, trust model manager 230 can generate feedback for retraining the AI model (e.g., the trained AI model) based on inequity list 212, influence factors 216 and hit list 702, additional aspects of which are disclosed with reference to subsequent figures.

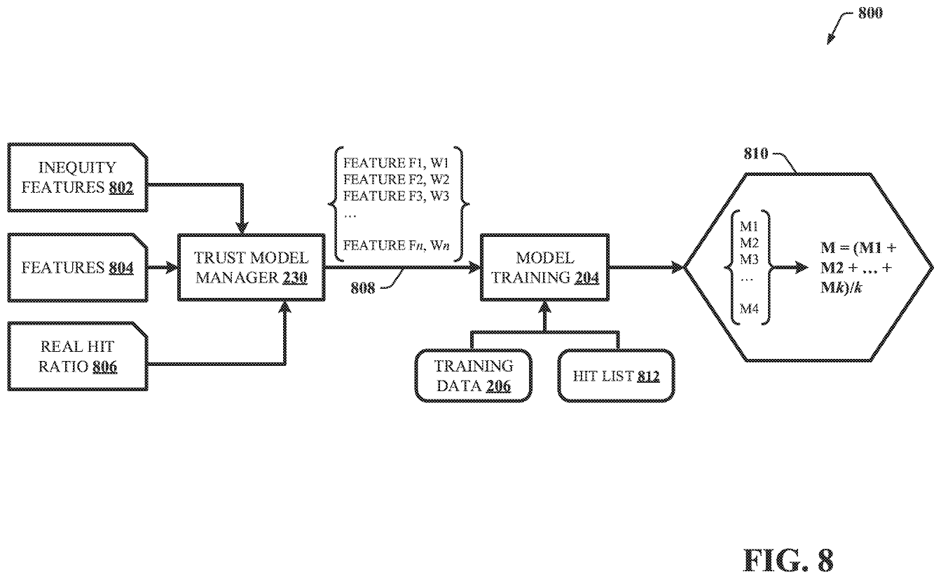

FIG. 8 illustrates a flow diagram of an example, non-limiting method 800 that can enable training an AI model based on factors derived from testing data of the AI model in accordance with one or more embodiments described herein. Repetitive description of like elements and/or processes employed in respective embodiments is omitted for sake of brevity.

As discussed with reference to FIG. 2, trust model manager 230 can collect information from trust monitor component 114 (FIG. 1) to decide whether to retrain an AI model (e.g., trained AI model) using the information. For example, trust model manager 230 can acquire inequity features 802 with inequity ratios over a threshold, features 804 with top N influence factors (e.g., IF (f)), and real hit ratio 806 from trust monitor component 114. An average value of the influence factors can be represented as avg (IF), wherein avg (IF) can be computed (e.g., by trust monitor component 114) according to equation 3.

avg(IF)=Sum(influence factor for a feature)/N, wherein N can be the number of features. Equation 3:

Trust model manager 230 can check whether real hit ratio 806 exceeds a defined threshold (e.g., whether real hit ratio 806 is lower than a defined threshold (i.e., second threshold)) or when the inequity ratio is higher than a threshold. Trust model manager 230 can trigger a retrain of the AI model (e.g., trained AI model) at intervals (e.g., defined time intervals), when real hit ratio 806 is lower that the defined threshold (i.e., second threshold), or when the inequity ratio is over the threshold, using the top N influence factors (e.g., one or more features from testing data 120 having influence factors above a defined threshold (i.e., first threshold)). For example, when an inequity ratio for a feature exceeds a threshold, an influence factor for the corresponding feature can be adjusted. More specifically, inequity features 802 can comprise feature F1, feature F2, . . . , feature Fn (e.g., CPU utilization, TranRate, CL1 elapse time, DB log rate, etc.), and trust model manager 230 can adjust respective weights w1, w2, . . . , wn of the features F1, F2, . . . , Fn. Trust model manager 230 can use influence factors as initial weights for respective inequity features 802 and adjust the initial weights for inequity features 802, wherein adjusting an initial weight for a feature can comprise, for example, lowering a weight of the inequity feature such than influence of the inequity feature on performance of the AI model can be reduced.

Trust model manager 230 can request training component 118 to retrain the AI model, and training component 118 (FIG. 1) can use training data 206 and data from hit list 812 to retrain the AI model at model training 204. For an inequity feature, trust model manager 230 can adjust a weight to | IF (f)-avg (IF)|, then sort a weight list to generate a sorted weight list for features (e.g., w1, w2, . . . , wn). Trust model manager 230 can sort the weight list in decreasing order (e.g., w1>w2> . . . >wn). For n number of features and m number of inequity features k decision tree models can be created with feature importance. One decision tree can correspond to one AI model and multiple decision trees corresponding to multiple AI models can be created. For example, using the sorted weight list for features (e.g., w1, w2, . . . , wn), models M1, M2, . . . , Mk can be generated, and a decision tree model can be created based on equation 3. Models M1, M2, . . . , Mk can be generated by using a decision tree algorithm.

Equation 3: M=(M1+M2+ . . . +Mk)/k, wherein M1, M2, etc. can represent the AI models and k can indicated a total number of the AI models.

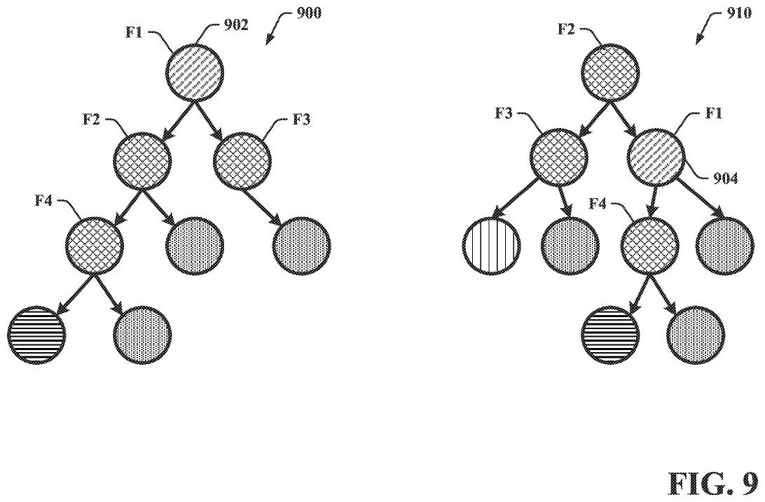

FIG. 9 illustrates example, non-limiting decision trees 900 and 910 for an AI model trained to predict a status of a DBMS in accordance with one or more embodiments described herein. Repetitive description of like elements and/or processes employed in respective embodiments is omitted for sake of brevity.

With continued reference to FIG. 8, training component 118 (FIG. 1) can use feedback generated by trust model manager 230 to train the AI model, wherein the feedback can comprise features with sorted influence factors (e.g., F1, F2, . . . , Fn). For example, for an inequity feature F1, a decision tree for the AI model (e.g., trained AI model) can be changed to decrease influence of the inequity feature F1. For example, decision tree 900 can correspond to an AI model (e.g., trained AI model) comprising features F1, F2, F3, F4, etc., wherein F1 can be an inequity feature. Upon receiving feedback from trust model manager 230 that an inequity ratio of F1 is over a threshold, training component 118 can adjust decision tree 900 to reduce the influence of F1 resulting in decision tree 910. That is, F1 can be adjusted to a position within decision tree 910 such that F1 can have lower importance on predictions made by the AI model. For example, feature F1 can be moved from position 902 (towards the top of decision tree 900) to position 904 (towards the bottom of decision tree 910). Changing the position of F1 can influence division of a training dataset in a decision tree 910, wherein the new position (e.g., position 904) of F1 can be decided based on a weight of F1 in a weight list (e.g., w1, w2, . . . , wn). In FIG. 9, like circles are illustrated with like patterns, and circles with different patterns in decision trees 900 and 910 can indicate different features in the decision trees. For example, feature F1 can be CL1 elapse time and feature F2 can be CL2 CPU time.

Retraining the AI model can result in trustworthy and explicable AI models that can dynamically predict a status of a system with interpretability and fairness. Retraining the AI model via the one or more methods indicated herein can avoid unfairness that can be brought by a system operator or an SME when dealing with training data. Various embodiments herein can enable dynamic checks of the runtime data to monitor deviation of an AI model at runtime, that can adapt to changing workloads or environments.

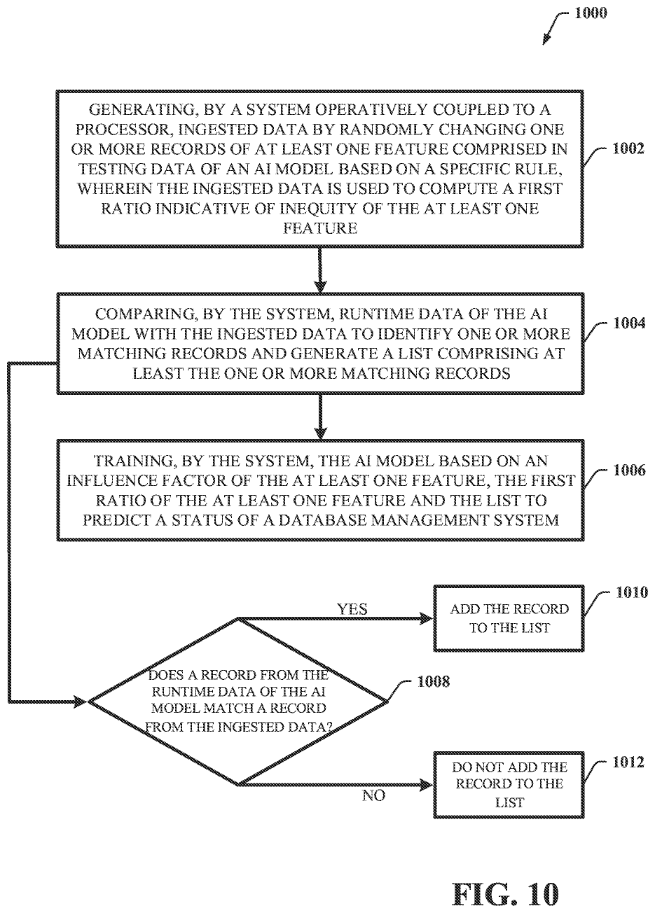

FIG. 10 illustrates a flow diagram of an example, non-limiting method 1000 that can train an AI model to predict a status of a DBMS in accordance with one or more embodiments described herein. Repetitive description of like elements and/or processes employed in respective embodiments is omitted for sake of brevity.

At 1002, the non-limiting method 1000 can comprise generating (e.g., by data ingestion component 110), by a system operatively coupled to a processor, ingested data by randomly changing one or more records of at least one feature comprised in testing data of an AI model based on a specific rule, wherein the ingested data is used to compute a first ratio indicative of inequity of the at least one feature.

At 1004, the non-limiting method 1000 can comprise comparing (e.g., by runtime deviation check component 112), by the system, runtime data of the AI model with the ingested data to identify one or more matching records and generate a list comprising at least the one or more matching records.

At 1006, the non-limiting method 1000 can comprise training (e.g., training component 118), by the system, the AI model based on an influence factor of the at least one feature, the first ratio of the at least one feature and the list to predict a status of a database management system.

At 1008, the non-limiting method 1000 can comprise determining (e.g., by runtime deviation check component 112) whether a record from the runtime data of the AI model matches a record from the ingested data. If yes, at 1010, the record can be added to the list. If no, at 1012, the record is not added to the list.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively extract one or more influence factors for one or more respective features of testing data of an AI model, use the one or more influence factors to generate ingested data for the AI model, and perform a runtime deviation check for the AI model using the ingested data and runtime data of the AI model as the one or more embodiments described herein can enable this process. And, neither can the human mind nor a human with pen and paper train the AI model to determine a status of a system (e.g., a database management system), as conducted by one or more embodiments described herein.

FIG. 11 illustrates a block diagram of an example, non-limiting, operating environment in which one or more embodiments described herein can be facilitated. FIG. 11 and the following discussion are intended to provide a general description of a suitable operating environment 1100 in which one or more embodiments described herein at FIGS. 1-10 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as inequity and runtime deviation monitoring code 1145. In addition to block 1145, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1145, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 18. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1145 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in block 1145 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a data ingestion component that uses testing data of an artificial intelligence (AI) model to generate ingested data by randomly changing one or more records of at least one feature comprised in the testing data based on a specific rule, wherein the ingested data is used to compute a first ratio indicative of inequity of the at least one feature;
a runtime deviation check component that compares runtime data of the AI model with the ingested data to identify one or more matching records and generate a list comprising at least the one or more matching records; and
a training component that trains the AI model based on an influence factor of the at least one feature, the first ratio of the at least one feature and the list to predict a status of a database management system.

2. The system of claim 1, further comprising:
an extraction component that extracts one or more influence factors for one or more respective features of the testing data, wherein the at least one feature is selected for generating the ingested data based on the influence factor being greater than a first threshold.

3. The system of claim 1, wherein generating the ingested data comprises generating one or more ingested records for the at least one feature based on one or more existing records for the at least one feature in the testing data.

4. The system of claim 1, wherein the first ratio is generated based on an amount of records comprised in the ingested data and an inequity count of the at least one feature determined using the AI model.

5. The system of claim 4, wherein the inequity count is determined by comparing prediction results generated by the AI model based on processing one or more records in testing data of the AI model and based on processing one or more ingested records.

6. The system of claim 1, wherein the list further comprises prediction results generated by the AI model based on processing the one or more matching records, and wherein the runtime deviation check component uses the prediction results to determine runtime deviation of the AI model.

7. The system of claim 1, further comprising:
a trust monitor component that monitors the influence factor for the at least one feature, the first ratio of the at least one feature and the list to generate a second ratio.

8. The system of claim 7, further comprising:
a trust model manager component that generates feedback for training the AI model based on at least the first ratio being greater than a threshold or the second ratio being lower than a second threshold.

9. The system of claim 1, wherein the AI model is trained to predict the status of the database management system while maintaining inequity and runtime deviation of the AI model below respective thresholds.

10. A computer-implemented method, comprising:
generating, by a system operatively coupled to a processor, ingested data by randomly changing one or more records of at least one feature comprised in testing data of an AI model based on a specific rule, wherein the ingested data is used to compute a first ratio indicative of inequity of the at least one feature;
comparing, by the system, runtime data of the AI model with the ingested data to identify one or more matching records and generate a list comprising at least the one or more matching records; and
training, by the system, the AI model based on an influence factor of the at least one feature, the first ratio of the at least one feature and the list to predict a status of a database management system.

11. The computer-implemented method of claim 10, further comprising:
extracting, by the system, one or more influence factors for one or more respective features of the testing data, wherein the at least one feature is selected for generating the ingested data based on the influence factor being greater than a first threshold.

12. The computer-implemented method of claim 10, further comprising:
generating, by the system, generating one or more ingested records for the at least one feature based on one or more existing records for the at least one feature in the testing data.

13. The computer-implemented method of claim 10, further comprising:
generating, by the system, the first ratio based on an amount of records comprised in the ingested data and an inequity count of the at least one feature determined using the AI model.

14. The computer-implemented method of claim 13, further comprising:
determining, by the system, the inequity count by comparing prediction results generated by the AI model based on processing one or more records in testing data of the AI model and based on processing one or more ingested records.

15. The computer-implemented method of claim 10, wherein the list further comprises prediction results generated by the AI model based on processing the one or more matching records, and wherein the prediction results are used to determine runtime deviation of the AI model.

16. The computer-implemented method of claim 9, further comprising:
monitoring, by the system, the influence factor for the at least one feature, the first ratio of the at least one feature and the list to generate a second ratio; and
generating, by the system, feedback for training the AI model based on at least the first ratio being greater than a threshold or the second ratio being lower than a second threshold.

17. A computer program product for training an AI model to improve robustness of the AI model to training inequity and runtime deviation, the computer program product comprising a computer readable storage medium having program instructions embodied therewith, the program instructions executable by a processor to cause the processor to:
generate, by the processor, ingested data by randomly changing one or more records of at least one feature comprised in testing data of an AI model based on a specific rule, wherein the ingested data is used to compute a first ratio indicative of inequity of the at least one feature;
compare, by the processor, runtime data of the AI model with the ingested data to identify one or more matching records and generate a list comprising at least the one or more matching records; and
train, by the processor, the AI model based on an influence factor of the at least one feature, the first ratio of the at least one feature and the list to predict a status of a database management system.

18. The computer program product of claim 17, wherein the program instructions are further executable by the processor to cause the processor to:
extract, by the processor, one or more influence factors for one or more respective features of the testing data, wherein the at least one feature is selected for generating the ingested data based on the influence factor being greater than a first threshold.

19. The computer program product of claim 17, wherein the program instructions are further executable by the processor to cause the processor to:
generate, by the processor, one or more ingested records for the at least one feature according to one or more existing records for the at least one feature in the testing data.

20. The computer program product of claim 17, wherein the program instructions are further executable by the processor to cause the processor to:
generate, by the processor, the first ratio based on an amount of records comprised in the ingested data and an inequity count of the at least one feature determined using the AI model.
